(19) United States
(12) Patent Application Publication
(10) Pub. No.: US 2025/0353351 A1
(43) Pub. Date: Nov. 20, 2025

(54) AIR CONDITIONER FOR VEHICLE

(71) Applicant: Hanon Systems, Daejeon (KR)

(72) Inventors: Yong Ho Kim, Daejeon (KR); Yong Seon Lee, Daejeon (KR); Jae Won Jeong, Daejeon (KR)

(21) Appl. No.: 18/726,471

(22) PCT Filed: Mar. 3, 2023
(86) PCT No.: PCT/KR2023/002890

§ 371 Date: Jul. 3, 2024

(30) Foreign Application Priority Data
Mar. 28, 2022 (KR) 10-2022-0037768

(51) Int. Cl. B60H 1/00

(52) U.S. Cl. CPC B60H 1/00671

(57) ABSTRACT

Disclosed is an air conditioner for a vehicle, which prevents the influence of electronic parts by various external environmental factors, blocks various refrigerant noise and coolant noise, and minimizes the package size and simplifies a layout to be able to reduce costs. The air conditioner for a vehicle comprises an air conditioning case having an air passage therein, a cooling means and a heating means provided in the air passage of the air conditioning case, a blower unit for blowing air into the air passage, and a door for adjusting the opening degree of the air passage. The door and electronic parts for driving the door are all disposed in the air conditioning case on the indoor side of the vehicle.

### TECHNICAL FIELD

The present invention relates to an air conditioner for a vehicle, and more specifically, to an air conditioner for a vehicle formed by combination of an outdoor unit and an indoor unit, which are divided based on a dash panel of a vehicle.

### BACKGROUND ART

In general, an air conditioner for a vehicle is an apparatus for cooling or heating the interior of the vehicle by cooling or heating through the process of introducing outdoor air into the interior of the vehicle or circulating indoor air of the vehicle. Such an air conditioner for a vehicle includes an evaporator for a cooling action and a heater core for a heating action inside an air-conditioning case, and selectively blows the air cooled by the evaporator or heated by the heater core toward parts of the interior of the vehicle.

Recently, to maximize the interior space, an air conditioner for a vehicle installed in an electric vehicle is configured such that a heat exchanger like a blower unit, an evaporator, and a condenser, a compressor, an expansion valve, and the likes are located at an outdoor side based on a dashboard and only a discharge duct is arranged at an indoor side. Such an air conditioner is called a split type air conditioner formed by combination of an outdoor unit and an indoor unit, which are divided based on a dashboard of a vehicle.

Referring to FIG. 1, a conventional split type air conditioner includes a blower unit, an outdoor unit 1, and an indoor unit 2. The outdoor unit 1 and the indoor unit 2 are combined together, wherein the outdoor unit 1 is placed on the outdoor side based on a dash panel 50 f the vehicle, and the indoor unit 2 is placed on the indoor side. The blower unit blows air into an air passage of the outdoor unit 1.

The outdoor unit 1 includes an outdoor unit case 10. On one side of the outdoor unit case 10, an air inlet 11 connected to the blower unit is formed, and an evaporator 12 and a condenser 13 are sequentially equipped in an air flow direction inside an inner air passage. The evaporator 12 is a cooling means which cools the air passing through the evaporator, and the condenser 13 is a heating means which heats the air passing through the condenser. A plurality of temperature doors are provided between the evaporator 12 and the condenser 13.

The temperature doors control the amount of cold air passing through the evaporator 12 and the warm air passing through the condenser 13 to adjust the temperature of the air discharged into the interior of the vehicle. The temperature doors include a front seat temperature door for adjusting the temperature of the front seat of the vehicle, and a rear seat temperature door 15 for adjusting the temperature of the rear seat. The front seat temperature door includes a first front seat temperature door 17 and a second front seat temperature door 16.

The indoor unit 2 has an indoor unit case 20. The indoor unit case 20 is combined with the outdoor unit case 10 across the dash panel 50. Additionally, the indoor unit case 20 includes a plurality of air outlets. The air outlets includes a front seat air outlet for blowing air to the front seats and a rear seat air outlet for blowing air to the rear seats.

The front seat air outlet includes a defrost vent which blows air toward the window side, a face vent which blows air toward a passenger's face, and a front seat floor vent which blows air toward the passenger's feet. The rear seat air outlet includes a console vent (or B-pillar) and a rear seat floor vent.

An electric heater 24 such as a PTC heater is installed inside the indoor unit case 20, and an auxiliary front seat temperature door 23 and an auxiliary rear seat temperature door 22 are provided downstream of the electric heater 24 in the air flow direction. Moreover, the indoor unit case 20 includes a rear seat on-off door 21 provided in a cold air passage of the rear seat to control the amount of cold air toward the rear seats. The auxiliary front seat temperature door 23 and the auxiliary rear seat temperature door 22 are installed downstream of the condenser 13 and electric heater 24 in the air flow direction to minimize heat loss.

The indoor unit case 20 includes a plurality of mode doors. The mode doors include a defrost door 25 which adjusts the opening degree of a defrost vent, a vent door 26 which adjusts the opening degree of a face vent, a floor door 27 which adjusts the opening degree of a front seat floor vent, and a rear seat mode door which adjusts the opening degree of the rear seat air outlet.

That is, the first front seat temperature door 17, the second front seat temperature door 16, and the rear seat temperature door 15 are all installed in the outdoor unit case 10 and positioned on the outdoor side of the vehicle. In addition, actuators which drive the first front seat temperature door 17, the second front seat temperature door 16, and the rear seat temperature door 15 are all located on the outdoor side of the vehicle. Due to the characteristics of electric vehicles which have narrow spaces, all of the heat exchangers cannot be arranged in the indoor side of the vehicle.

As a result, the conventional air conditioner for a vehicle, which includes electronic parts, such as actuators, to operate the doors located on the outdoor side of the vehicle, has several disadvantages in that the actuators malfunction due to external environmental conditions, namely, fail to operate smoothly by cooling during winter, and in that the lifespan of products is reduced. If having an insulation structure or a cover on the outdoor side actuator to solve environmental problems, the conventional air conditioner for a vehicle has a disadvantage in that the manufacturing cost is increased. In addition, the conventional air conditioner for a vehicle has further disadvantages in that the size is increased and the layout is complicated since all of the heat exchangers cannot be positioned on the outdoor side of the vehicle.

### DISCLOSURE

### Technical Problem

Accordingly, the present invention has been made in view of the above-mentioned problems occurring in the related art, and it is an object of the present invention to provide an air conditioner for a vehicle, which can prevent the influence of electronic parts by various external environmental factors, block various noises, such as refrigerant noise and coolant noise, and minimize the package size and simplify the layout, thereby reducing costs.

### Technical Solution

To accomplish the above-mentioned objects, according to the present invention, there is provided an air conditioner for a vehicle including an air conditioning case having an air passage therein, a cooling means and a heating means provided in the air passage of the air conditioning case, a blower unit for blowing air into the air passage, and doors for adjusting the opening degree of the air passage, wherein the doors and electronic parts for driving the doors are all provided in the air conditioning case of the indoor side of the vehicle.

Moreover, the air conditioner for a vehicle further includes an outdoor unit positioned on an outdoor side based on a dash panel of the vehicle, and an indoor unit positioned on an indoor side based on the dash panel of the vehicle and coupled with the outdoor unit, wherein the doors and the electronic parts are all installed in the indoor unit.

The electronic parts include actuators which rotate the doors.

The cooling means and the heating means are all positioned in the air conditioning case of the outdoor side of the vehicle.

At least one temperature door is provided in the air passage of the air conditioning case to adjust discharge temperature by adjusting the amount of air passing through the heating means and the amount of air bypassing the heating means, and the temperature door and the actuator which drives the temperature door are positioned in the air conditioning case of the indoor side of the vehicle.

The temperature door is positioned downstream of the heating means in an air flow direction.

The cooling means includes an evaporator which cools the air with refrigerant, and the heating means includes a condenser which heats the air with refrigerant and an electric heater which heats the air by electrical heating, and the evaporator, the condenser, and the electric heater are all positioned in the air conditioning case of the outdoor side of the vehicle.

The doors includes at least one temperature door for controlling the discharge temperature and at least one mode door for controlling the airflow of each outlet, and the temperature door and the mode door are all positioned in the air conditioning case of the indoor side of the vehicle based on the dash panel of the vehicle, and the air passing through the cooling means and the heating means directly reaches the air passage of the indoor side air conditioning case without any resistance.

The outdoor unit includes an outdoor unit case, and the cooling means and the heating means are sequentially provided inside the outdoor unit case, and a partition which divides the air passage into an upper air passage and a lower air passage is formed between the cooling means and the heating means.

The indoor unit includes an indoor unit case, and a partition extending from the partition of the outdoor unit is formed inside the indoor unit case, and based on the partition of the outdoor unit case, the upper air passage communicates with an upper air outlet, and the lower air passage communicates with a lower air outlet.

The indoor unit includes an indoor unit case, and a partition extending from the partition of the outdoor unit is formed inside the indoor unit case. A first temperature door which adjusts the amount of air passing through the heating means and the amount of air bypassing the heating means is provided in the upper air passage of the indoor unit case, and a second temperature door which adjusts the amount of air passing through the heating means and the amount of air bypassing the heating means is provided in the lower air passage.

The first temperature door and the second temperature door are formed in a dome door type.

The outdoor unit includes an outdoor unit case, and the cooling means and the heating means are sequentially provided inside the outdoor unit case, and the indoor unit includes an indoor unit case, and a temperature door which adjusts the amount of air passing through the heating means and the amount of air bypassing the heating means is provided inside the indoor unit case.

The actuator is installed on the exterior of the air conditioning case of the indoor side of the vehicle.

### Advantageous Effect

The air conditioner for a vehicle according to the present invention can prevent influences on the electronic parts by various external environmental factors by positioning all the electronic parts, such as actuators for operating the doors, on the indoor side, thereby preventing malfunctions, increasing the lifespan of products, and ensuring stable quality.

In addition, the air conditioner for a vehicle according to the present invention can block various noises, such as refrigerant noise and coolant noise, minimize the size of the package, and expand the interior space of the vehicle by positioning all the heat exchangers on the outdoor side, and can enhance safety, simplify the layout and reduce the number of components and the costs by positioning the dangerous high-voltage PTC heater on the outdoor side.

### DESCRIPTION OF DRAWINGS

FIG. 1 is a cross-sectional view illustrating a conventional split type air conditioner for a vehicle.

FIG. 2 is a cross-sectional view illustrating an air conditioner for a vehicle according to a first embodiment of the present invention.

FIG. 3 is an exploded cross-sectional view illustrating the air conditioner for a vehicle according to the first embodiment of the present invention.

FIG. 4 is a view illustrating a state in which an actuator is installed in the air conditioner for a vehicle according to the first embodiment of the present invention.

FIG. 5 is a cross-sectional view illustrating a cooling mode of the air conditioner for a vehicle according to the first embodiment of the present invention.

FIG. 6 is a cross-sectional view illustrating a heating mode of the air conditioner for a vehicle according to the first embodiment of the present invention.

FIG. 7 is a cross-sectional view illustrating an air conditioner for a vehicle according to a second embodiment of the present invention.

FIG. 8 is a cross-sectional view illustrating a cooling mode of the air conditioner for a vehicle according to the second embodiment of the present invention.

FIG. 9 is a cross-sectional view illustrating a heating mode of the air conditioner for a vehicle according to the second embodiment of the present invention.

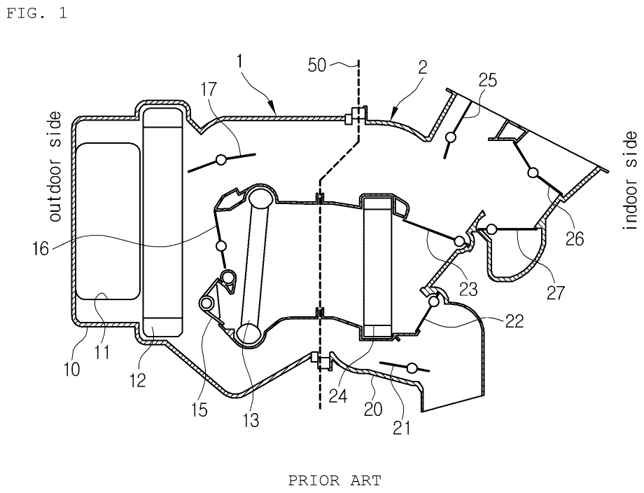

### MODE FOR INVENTION

Hereinafter, a technical configuration of an air conditioner for a vehicle will be described in detail with reference to the accompanying drawings.

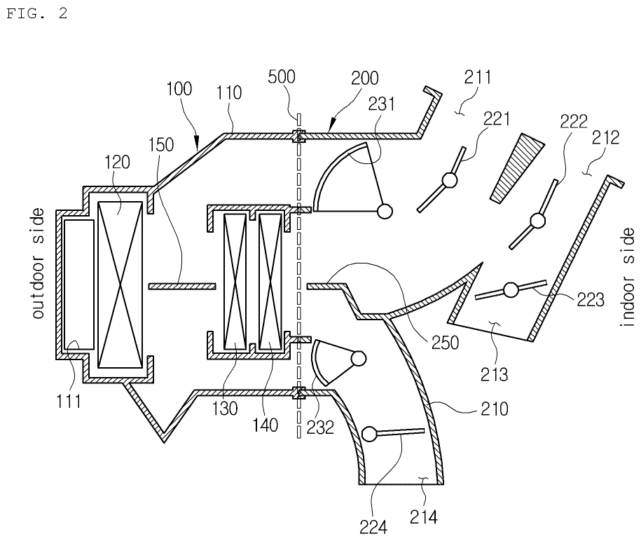

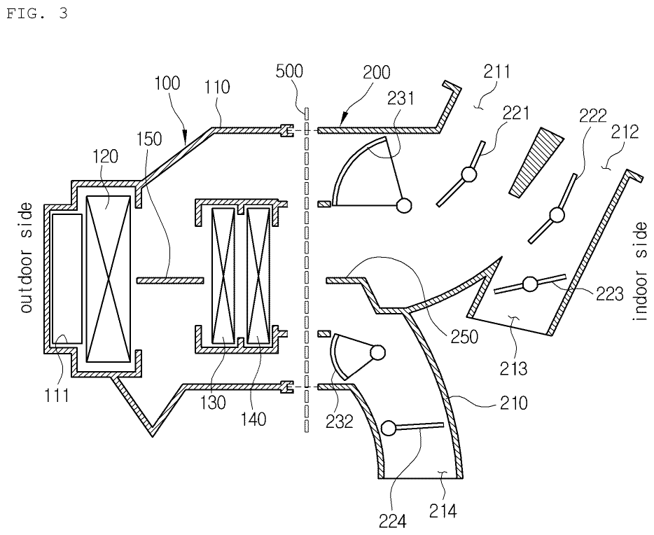

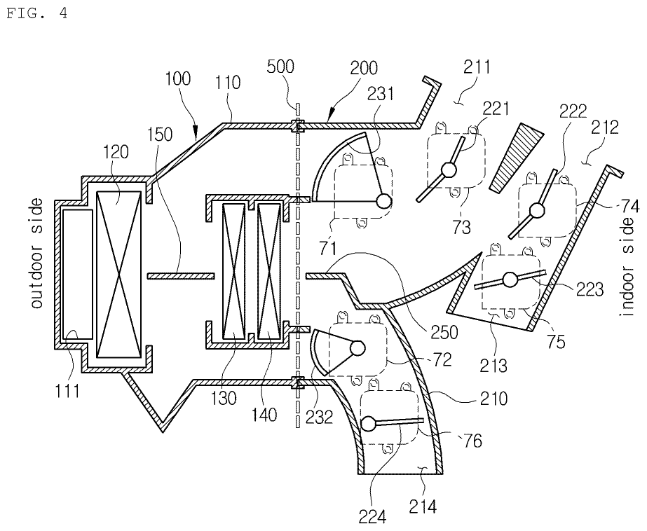

Referring to FIGS. 2 to 4, an air conditioner for a vehicle according to a first embodiment of the present invention includes an air conditioning case, a cooling means, a heating means, a blower unit, and a plurality of doors. The air conditioning case has an air passage inside, and the cooling means and the heating means are provided in the air passage of the air conditioning case. The blower unit blows air into the air passage, and the doors adjust the opening degree of the air passage.

The air conditioner for a vehicle includes an outdoor unit 100 and an indoor unit 200. The outdoor unit 100 and the indoor unit 200 are combined with each other. The outdoor unit 100 is positioned on the outdoor side based on a dash panel 500 of the vehicle, and the indoor unit 200 is positioned on the indoor side based on the dash panel 500 of the vehicle. The blower unit is connected to the outdoor unit 100 to blow air into the air passage of the outdoor unit 100.

In this case, the doors and the electronic parts are all positioned in the air conditioning case of the indoor side of the vehicle. The electronic parts include actuators that rotate the doors. The electronic parts include various parts such as cams, arms, and levers that transmit the power of the actuators to the doors. That is, the doors and the electronic parts are all installed in the indoor unit 200. Moreover, the cooling means and the heating means are positioned in the air conditioning case of the outdoor side of the vehicle. That is, the cooling means and the heating means are all installed in the outdoor unit 100.

The outdoor unit 100 includes an outdoor unit case 110. An air inlet 111 connected to the blower unit is formed on one side of the outdoor unit case 110, and the cooling means and the heating means are sequentially provided in the air passage inside according to an air flow direction. The cooling means includes an evaporator 120 cooling air with refrigerant, and the heating means includes a condenser 130 heating the air with refrigerant.

The evaporator 120 and the condenser 130 are installed on a refrigerant line circulating through a compressor and an expansion valve. The refrigerant circulating through the evaporator 120 exchanges heat with the air passing through the evaporator to cool the air, and the refrigerant circulating through the condenser 130 exchanges heat with the air passing through the condenser to heat the air. The heating means further includes an electric heater 140 arranged downstream of the condenser 130 in the air flow direction. The electric heater 140 may be a PTC heater heating the air by electrical heating.

As described above, all heat exchangers are positioned in the air conditioning case of the outdoor side of the vehicle. That is, as the evaporator 120, the condenser 130, and the electric heater 140 are all placed within the outdoor unit case 110, the air conditioner can block noises such as refrigerant noise and coolant noise, minimize the size of the package, and expand the interior space of the vehicle. Additionally, since the dangerous high-voltage PTC heater is positioned outside, the air conditioner can enhance safety. Moreover, the air conditioner can simplify the layout and reduce the number of components, thereby achieving cost reduction.

The indoor unit 200 includes an indoor unit case 210. A dash panel 500 is interposed between the indoor unit case 210 and the outdoor unit case 110, and the indoor unit case 210 and the outdoor unit case 110 are combined with each other. Coupling portions are respectively formed at end portions of the indoor unit case 210 and the outdoor unit case 110 facing each other. The indoor unit case 210 includes a plurality of air outlets. The air outlets include a front seat air outlet for discharging air to the front seats of the vehicle, and a rear seat air outlet 214 for discharging air to the rear seats of the vehicle.

The front seat air outlet includes a defrost vent 211 for blowing air towards the window side, a face vent 212 for blowing air towards a passenger's face, and a floor vent 213 for blowing air towards the passenger' feet. The rear seat air outlet 214 includes a console vent (or B-pillar) and a rear seat floor vent. Furthermore, the indoor unit case 210 includes a plurality of mode doors.

The mode doors include a defrost door 221 which adjusts the opening degree of the defrost vent 211, a vent door 222 which adjusts the opening degree of the face vent 212, a floor door 223 which adjusts the opening degree of the floor vent 213, and a rear seat mode door 224 which adjusts the opening degree of the rear seat air outlet 214. Each of the mode doors is connected to and rotated by an actuator. That is, the defrost door 221 is connected to a first actuator 73, the vent door 222 is connected to a second actuator 74, the floor door 223 is connected to a third actuator 75, and the rear seat mode door 224 is connected to a fourth actuator 76.

In addition, the air conditioner for a vehicle includes temperature doors. At least one of the temperature doors is installed in the air passage of the air conditioning case to adjust the amount of air passing through the heating means and the amount bypassing the heating means to adjust the discharge temperature of the air from the air outlets. In this case, the temperature door and the actuator which drives the temperature door are positioned in the air conditioning case of the indoor side of the vehicle. Moreover, the temperature door is positioned downstream of the heating means in the air flow direction.

That is, the doors include at least one temperature door and at least one mode door. The temperature door is for adjusting the discharge temperature of the air, and the mode door adjusts the airflow of the air outlets. Both the temperature door and the mode door are positioned in the air conditioning case of the indoor side of the vehicle, based on the dash panel 500 of the vehicle. In this case, the air passing through the cooling means and the heating means directly reaches the air passage of the indoor side air conditioning case without any resistance.

Meanwhile, the outdoor unit 100 includes a partition 150. The partition 150 is provided within the outdoor unit case 110, and is positioned between the cooling means and the heating means. The partition 150 divides the air passage within the outdoor unit case 110 into an upper air passage and a lower air passage. Additionally, the indoor unit 200 also includes a partition 250. In this case, the partition 250 of the indoor unit 200 is formed inside the indoor unit case 210 and extends from the partition 150 of the outdoor unit 100.

Based on the partition 250 of the indoor unit case 210, the upper air passage communicates with an upper air outlet, and the lower air passage communicates with a lower air outlet. That is, the defrost vent 211, the face vent 212, and the floor vent 213 are formed in the upper air passage based on the partition 250, and the rear seat air outlet 214 is formed in the lower air passage based on the partition 250.

As described above, the air passage inside the air conditioning case is divided into the upper part and the lower part by the partitions 150 and 250, thereby enabling independent air conditioning control for three zones: the driver's seat, the front passenger seat, and the rear seat of the vehicle.

Additionally, a first temperature door 231 is provided at the upper air passage of the indoor unit case 210, and a second temperature door 232 is provided at the lower air passage. The first temperature door 231 controls the amount of air in the warm air passage passing through the condenser 130 and the electric heater 140, and the amount of air in the upper cold air passage bypassing the condenser 130 and the electric heater 140. In addition, the second temperature door 232 adjusts the amount of air in the warm air passage passing through the condenser 130 and the electric heater 140, and the amount of air in the lower cold air passage bypassing the condenser 130 and the electric heater 140.

In this instance, both the first temperature door 231 and the second temperature door 232 are formed in a dome door type. Therefore, the size of the indoor unit case 210 in the front-to-rear direction of the vehicle can be reduced, facilitating a compact design. Furthermore, the temperature door is connected to the actuator to be rotated. That is, the first temperature door 231 is connected to a fifth actuator 71, and the second temperature door 232 is connected to a sixth actuator 72.

All actuators are mounted on the exterior of the air conditioning case on the indoor side of the vehicle. That is, the first actuator 73, the second actuator 74, the third actuator 75, the fourth actuator 76, the fifth actuator 71, and the sixth actuator 72 are all fixedly installed on the exterior of the indoor unit case 210. The above configuration prevents malfunctions and increases the lifespan of products by preventing the electronic parts from various external environmental factors, thereby ensuring stable quality.

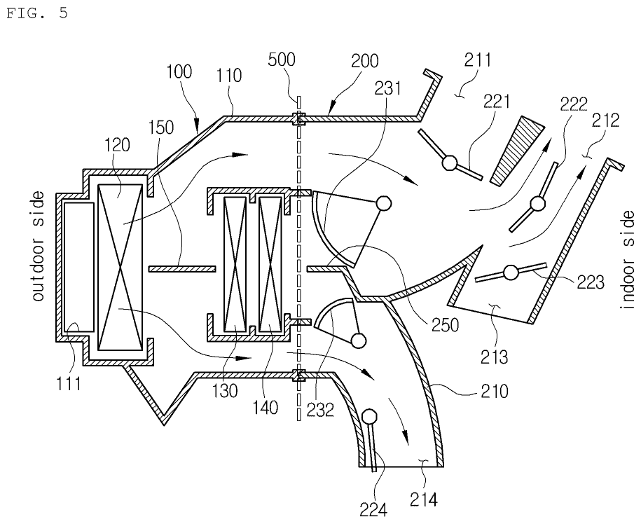

Referring to FIG. 5, in a cooling mode, the air blown by the blower unit is introduced into the air inlet 111 of the outdoor unit case 110, and is cooled by passing through the evaporator 120. In this case, the condenser 130 and the electric heater 140 are turned off, so the air is not heated.

The first temperature door 231 and the second temperature door 232 of the indoor unit case 210 close the warm air passage, and the air cooled by passing through the evaporator 120 passes through the upper cold air passage and the lower cold air passage and is discharged to the interior of the vehicle through the face vent 212 and the rear seat air outlet 214 of the indoor unit case 210.

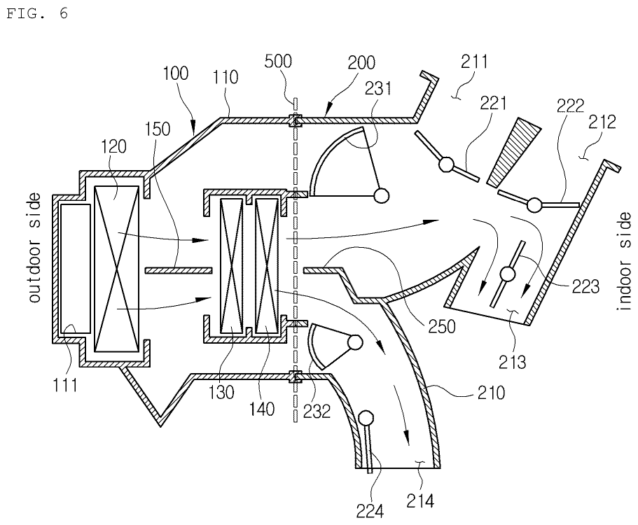

Referring to FIG. 6, in a heating mode, the air blown by the blower unit is introduced into the air inlet 111 of the outdoor unit case 110 and sequentially passes through the evaporator 120, the condenser 130, and the electric heater 140. In this case, since refrigerant does not flow into the evaporator 120, the evaporator 120 does not act as a heat exchanger. Additionally, the air passing through the condenser 130 and the electric heater 140 is heated.

The first temperature door 231 and the second temperature door 232 of the indoor unit case 210 open the warm air passages, and the air heated by passing through the condenser 130 and the electric heater 140 is discharged into the interior of the vehicle through the floor vent 213 after passing through the upper air passage, and then, is discharged into the interior of the vehicle through the rear seat air outlet 214 after passing through the lower air passage.

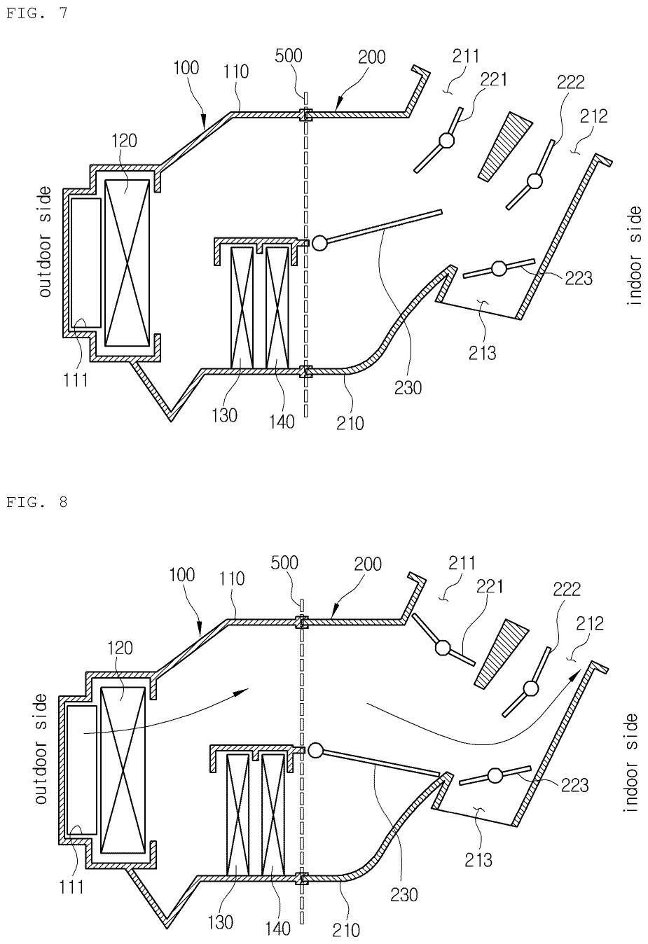

Meanwhile, referring to FIG. 7, an air conditioner for a vehicle according to a second embodiment of the invention includes an air conditioning case, a cooling means, a heating means, a blower unit, and a plurality of doors. The air conditioning case includes an air passage inside, and the cooling means and the heating means are provided in the air passage of the air conditioning case. The blower unit blows air into the air passage, and the doors adjust the opening degree of the air passage.

The second embodiment, in contrast to the first embodiment, does not have the partition within the air conditioning case, enabling independent air conditioning control for two zones: the driver's seat and the passenger seat in the front of the vehicle. The second embodiment will be briefly described only with respect to the configurations that differ from the first embodiment.

The air conditioner for a vehicle includes an outdoor unit 100 and an indoor unit 200. The outdoor unit 100 includes an outdoor unit case 110. An air inlet 111 connected to the blower unit is formed on one side of the outdoor unit case 110, and an evaporator 120, a condenser 130 and an electric heater 140 are sequentially provided inside the air passage. The indoor unit 200 includes an indoor unit case 210. A dash panel 500 is interposed between the indoor unit case 210 and the outdoor unit case 110, and the indoor unit case 210 is coupled with the outdoor unit case 110.

Additionally, the indoor unit case 210 includes a front seat air outlet having a defrost vent 211, a face vent 212, and a floor vent 213. Furthermore, the indoor unit case 210 includes a defrost door 221 which adjusts the opening degree of the defrost vent 211, a vent door 222 which adjusts the opening degree of the face vent 212, and a floor door 223 which adjusts the opening degree of the floor vent 213. Meanwhile, a temperature door 230 is also provided in the indoor unit case 210. The temperature door 230 adjusts the amount of air passing through the heating means and the air bypassing the heating means.

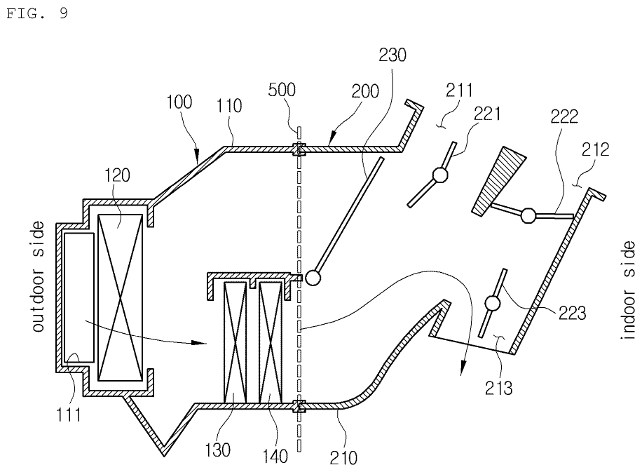

Referring to FIG. 8, in a cooling mode, the air blown by the blower unit is introduced into the air inlet 111 of the outdoor unit case 110 and is cooled by passing through the evaporator 120. In this case, the condenser 130 and the electric heater 140 are turned off, and the air is not heated.

The temperature door 230 of the indoor unit case 210 closes the warm air passage, and the air cooled by passing through the evaporator 120 passes through the cold air passage and is discharged into the interior of the vehicle through the face vent 212 in the indoor unit case 210.

Referring to FIG. 9, in a heating mode, the air blown by the blower unit is introduced into the air inlet 111 of the outdoor unit case 110 and sequentially passes through the evaporator 120, the condenser 130, and the electric heater 140. In this case, since refrigerant does not flow into the evaporator 120, the evaporator 120 does not act as a heat exchanger. Additionally, the air passing through the condenser 130 and the electric heater 140 is heated.

The temperature door 230 in the indoor unit case 210 opens the warm air passage, and the air heated by passing through the condenser 130 and the electric heater 140 passes through the warm air passage and is discharged into the interior of the vehicle after passing through the floor vent 213.

Although exemplary embodiments of the air conditioner for a vehicle according to the present invention have been described with reference to the drawings, it will be understood by those skilled in the art that various modifications and equivalents can be made without departing from the scope of the appended claims, which define the technical scope of the present invention.

1. An air conditioner for a vehicle comprising an air conditioning case having an air passage therein, a cooling means and a heating means provided in the air passage of the air conditioning case, a blower unit for blowing air into the air passage, and doors for adjusting the opening degree of the air passage,
wherein the doors and electronic parts for driving the doors are all provided in the air conditioning case of the indoor side of the vehicle.

2. The air conditioner for a vehicle according to claim 1, further comprising an outdoor unit positioned on an outdoor side based on a dash panel of the vehicle, and an indoor unit positioned on an indoor side based on the dash panel of the vehicle and coupled with the outdoor unit,
wherein the doors and the electronic parts are all installed in the indoor unit.

3. The air conditioner for a vehicle according to claim 1, wherein the electronic parts include actuators which rotate the doors.

4. The air conditioner for a vehicle according to claim 1, wherein the cooling means and the heating means are all positioned in the air conditioning case of the outdoor side of the vehicle.

5. The air conditioner for a vehicle according to claim 1, wherein at least one temperature door is provided in the air passage of the air conditioning case to adjust discharge temperature by adjusting the amount of air passing through the heating means and the amount of air bypassing the heating means, and
wherein the temperature door and the actuator which drives the temperature door are positioned in the air conditioning case of the indoor side of the vehicle.

6. The air conditioner for a vehicle according to claim 5, wherein the temperature door is positioned downstream of the heating means in an air flow direction.

7. The air conditioner for a vehicle according to claim 1, wherein the cooling means includes an evaporator which cools the air with refrigerant, and the heating means includes a condenser which heats the air with refrigerant and an electric heater which heats the air by electrical heating, and
wherein the evaporator, the condenser, and the electric heater are all positioned in the air conditioning case of the outdoor side of the vehicle.

8. The air conditioner for a vehicle according to claim 1, wherein the doors includes at least one temperature door for controlling the discharge temperature and at least one mode door for controlling the airflow of each outlet, and the temperature door and the mode door are all positioned in the air conditioning case of the indoor side of the vehicle based on the dash panel of the vehicle, and
wherein the air passing through the cooling means and the heating means directly reaches the air passage of the indoor side air conditioning case without any resistance.

9. The air conditioner for a vehicle according to claim 2, wherein the outdoor unit includes an outdoor unit case, and the cooling means and the heating means are sequentially provided inside the outdoor unit case, and
wherein a partition which divides the air passage into an upper air passage and a lower air passage is formed between the cooling means and the heating means.

10. The air conditioner for a vehicle according to claim 9, wherein the indoor unit includes an indoor unit case, and a partition extending from the partition of the outdoor unit is formed inside the indoor unit case, and
wherein based on the partition of the outdoor unit case, the upper air passage communicates with an upper air outlet, and the lower air passage communicates with a lower air outlet.

11. The air conditioner for a vehicle according to claim 9, wherein the indoor unit includes an indoor unit case, and a partition extending from the partition of the outdoor unit is formed inside the indoor unit case, and
wherein a first temperature door which adjusts the amount of air passing through the heating means and the amount of air bypassing the heating means is provided in the upper air passage of the indoor unit case, and a second temperature door which adjusts the amount of air passing through the heating means and the amount of air bypassing the heating means is provided in the lower air passage.

12. The air conditioner for a vehicle according to claim 11, wherein the first temperature door and the second temperature door are formed in a dome door type.

13. The air conditioner for a vehicle according to claim 2, wherein the outdoor unit includes an outdoor unit case, and the cooling means and the heating means are sequentially provided inside the outdoor unit case, and
wherein the indoor unit includes an indoor unit case, and a temperature door which adjusts the amount of air passing through the heating means and the amount of air bypassing the heating means is provided inside the indoor unit case.

14. The air conditioner for a vehicle according to claim 3, wherein the actuator is installed on the exterior of the air conditioning case of the indoor side of the vehicle.
